(19) United States
(12) Patent Application Publication
(10) Pub. No.: US 2006/0289658 A1
(43) Pub. Date: Dec. 28, 2006

(54) Processor circuit and method of allocating a logic chip to a memory chip

(75) Inventors: Wieland Fischer, Munich (DE); Jean-Pierre Seifert, Hillsborough, OR (US)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/370,192

(22) Filed: Mar. 6, 2006

Related U.S. Application Data
(63) Continuation of application No. PCT/EP04/08355, filed on Jul. 26, 2004.

(30) Foreign Application Priority Data
Sep. 4, 2003 (DE) 10 340 861.4

(51) Int. Cl. G06K 19/06

(52) U.S. Cl. 235/492

(57) ABSTRACT

A processor circuit includes a logic chip with a logic circuit and a non-volatile memory as well as a memory chip with a non-volatile memory. A key is stored in the non-volatile memory of the logic chip by using electronic fuses. Further, personalization information is stored, which signalizes that the logic chip is allocated to a memory chip. A chip identification encrypted with the key is stored in the memory chip at an ID memory area. During starting up the processor, it is first verified whether the encrypted logic chip identification stored in the memory chip is authentic or not. Thereby, a simple and inexpensive personalization of a memory chip to a logic chip can be obtain in order to ward off attacks with regard to the removal or manipulation, respectively, of the memory chip.

### CROSS-REFERENCE TO RELATED APPLICATION

This application is a continuation of copending International Application No. PCT/EP2004/008355, filed Jul. 26, 2004, which designated the United States and was not published in English.

### BACKGROUND OF THE INVENTION

1. Field of the Invention

The present invention relates to processor circuits and particularly to a processor circuit with a logic chip and a memory chip.

2. Description of the Related Art

Particularly in chip cards, normally, a non-volatile memory (NVM) is integrated on a chip with a CPU circuit. This means that the integrated circuit has both a memory area with memory transistors and a logic region with logic circuits forming the CPU. At the core, typical CPUs consist of logic circuits which are configured such that they can, on the one hand, perform the logic basic functions and, on the other hand, perform higher functions, such as adding, etc. Depending on the application, the logic circuits are further configured to be able to perform further mathematical functions. A non-volatile memory is associated to such logic circuits, for example in the form of an EPROM, EEPROM or a flash memory. Non-volatile memories are required in that they maintain the stored information even when a supply voltage is disconnected, in contrast to working memories in the form of an RAM memory. As is known, such non-volatile memories are particularly required so that a processor circuit can initialize to a certain condition after switching on the same, which means after energizing the processor circuit. This is also referred to in the art as startup or boot.

Particularly for security-relevant applications, but also when other access limitations of any type exist, wherein these access limitations are stored, for example, in the non-volatile memory, which means when generally the access to the CPU or logic circuit, respectively, is regulated by data stored in the NVM, an attack to this access regulation would be, for example, to remove or delete non-volatile memory or to write other data on the same. Removing the non-volatile memory from the integrated circuit, which includes both the non-volatile memory and the logic circuit, however, is not possible. Thus, in such applications, an attacker cannot read out or change secret data from the non-volatile memory after he has removed the same. Here, apart from the mentioned access limitation data, the code intended for the chip or generally the behavior of the chip, respectively, is also significant.

Such integrated circuits with an embedded non-volatile memory are particularly used in the field of chip cards.

On the other hand, it is known that the production processes for logic circuits are not a hundred percent compatible with the production processes for memories. This means that certain production steps are required for memory production, which again results in the fact that logic circuits cannot be generated with maximum speed. On the other hand, when logic circuits are to be produced with maximum speed, production steps can be required which again cause the generated memory to have a lower quality or to be slower or less densely packed. Thus, the need is rather to produce logic chips on the one hand and memory chips on the other hand separate from each other and to connect them on a carrier, such as a PCB (PCB=printed circuit board) so that overall a circuit is obtained which has, on the one hand, a high logic performance and, on the other hand, a high memory performance.

In addition, it should be noted that when no circuits have to be produced, which include both logic circuits and memory circuits, cost savings can be achieved. Thus, it has been found out that it is generally more expensive to integrate both logic elements and memory elements on a chip, as in the case of chip cards. It is significantly less expensive—particularly when space requirements permit it—to produce memory chips on the one hand and logic chips on the other hand, since optimizations can then be performed separately for a certain application with regard to costs and required performance.

Thus, for such an application, it is preferred to integrate at least one logic chip and at least one memory chip with a non-volatile memory on a carrier. However, this leads to the fact that an attacker is able to remove the original memory chip from the carrier and to replace the same by another memory chip programmed correspondingly.

In certain applications, which do not require such a high degree of security, as is the case with chip cards, an attacker could already obtain free access to actually access-limited functions of the logic chip by deleting the memory chip. On the other hand, in such a case, an attacker could also be able to run his own code on the chip by deleting the original memory chip, which again could have the effect that he can illegally use access-limited functions of the chip and possibly spy them out.

### SUMMARY OF THE INVENTION

It is an object of the present invention to provide a secure concept for allocating a logic chip to a memory chip.

In accordance with a first aspect, a processor circuit according to one embodiment includes a logic chip with a logic circuit and a non-volatile memory; as well as a memory chip with a non-volatile memory. The non-volatile memory of the logic chip is a memory area wherein a key is stored, and the non-volatile memory of the memory chip includes an identification memory area wherein an identification of the logic chip encrypted by using the key is stored. The non-volatile memory of the logic chip includes a further memory area wherein personalization information is stored, indicating in a set state that the logic chip and the memory chip are allocated to each other, and indicating in a non-set state that the logic chip is not allocated to a memory chip.

In accordance with a second aspect, a method according to the present invention is directed to allocating a logic chip to a logic circuit and a non-volatile memory to a memory chip with a non-volatile memory. The method includes the steps of: providing a key and storing the key in the non-volatile memory of the logic chip; encrypting an identification of the logic chip by using the key to obtain an encrypted identification; and storing the encrypted identification of the logic chip in an identification memory area of the non-volatile memory of the memory chip; storing personalization information in the non-volatile memory of the logic chip, wherein the personalization information indicates in a set state that the logic chip and the memory chip are allocated to each other, and wherein the personalization information indicates in a non-set state that the logic chip is not allocated to a memory chip.

In accordance with a third aspect, a method according to the present invention is directed to operating a processor circuit with a logic chip with a logic circuit and a non-volatile memory and a memory chip with an identification memory area and a further memory area. The method includes the steps of: reading out the identification memory area of the logic chip to obtain a read-out result; reading out the further memory area of the non-volatile memory of the logic chip to obtain a read-out result; determining whether the read-out result includes personalization information, wherein the personalization information indicates in a set state that the logic chip and the memory chip are allocated to each other, and wherein the personalization information indicates in a non-set state that the logic chip is not allocated to a memory chip; and verifying that the read-out result is an identification of the logic chip encrypted by using the key stored in the logic chip, only when the personalization information indicates in a set state that the logic chip and the memory chip are allocated to each other; with a positive result of the step of verifying, enabling further steps, where the logic chip and the memory chip are involved, otherwise taking a security measure.

In accordance with a fourth aspect, a computer program according to the present invention includes a program code for performing one of the above-mentioned methods when the program runs on a computer.

### BRIEF DESCRIPTION OF THE DRAWINGS

These and other objects and features of the present invention will become clear from the following description taken in conjunction with the accompanying drawings, in which:

FIG. 1 is a block diagram of an inventive processor circuit;

FIG. 2 is a flow diagram for representing the method of allocating a logic chip to a memory chip;

FIG. 3 is a flow diagram for representing the method of operating a processor circuit; and

FIG. 4 is a flow diagram for representing the method of operating a processor circuit according to a preferred embodiment of the present invention.

### DESCRIPTION OF THE PREFERRED EMBODIMENTS

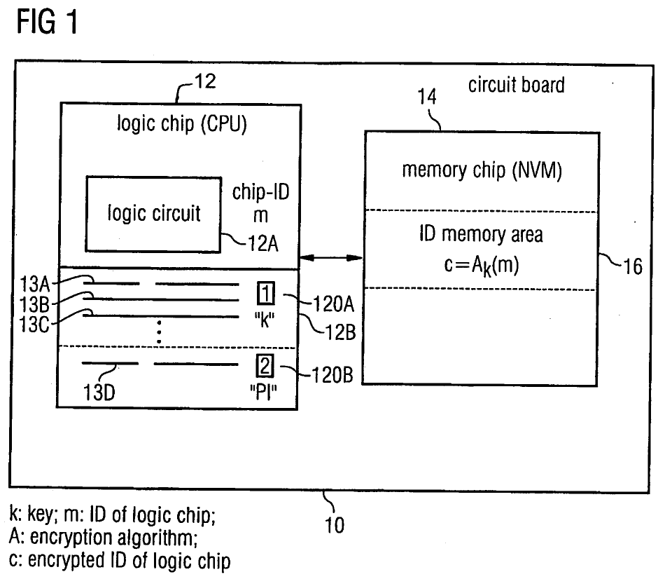

FIG. 1 shows an overview representation of a processor circuit according to the present invention. The processor circuit includes a carrier 10 which is a circuit board, particularly a printed circuit board in the preferred embodiment. A logic chip 12 on the one hand, and a memory chip 14 on the other hand are disposed on the circuit board. It should be noted that of course several logic chips or several memory chips, respectively, can be disposed. Logic chip 12, which can, for example, be a CPU, includes, on the one hand, a logic circuit 12a as well as a non-volatile memory 12b. The non-volatile memory 12b is divided into a first part 120a and into a second part 120b. In the first part 120a, a key k can be stored, while personalization information PI can be stored in the second part 120b. Preferably, the non-volatile memory 12b of the logic chip is designed as a fusing block, which means an array of individual fuses 13a, 13b, 13c, 13d. In the example shown in FIG. 1, the fuses or electronic fuses 13a and 13d, respectively, are burned or “shot”, while the fuses 13b, 13c are intact. As it is known, electronic fuses are “programmed” irreversibly in that the fuses are burned to represent a first logic state or are not touched for representing a second logic state differing from the first logic state. A fuse could, for example, be a simple line having a thin portion, which can be burned by applying a high voltage in that a high current flows through the line. Alternatively, fuses can also be designed by using a transistor, wherein, for example, the gate source path of the transistor can be used as a fuse. In an intact transistor, this path has a very high resistance. For burning such a transistor, which means for destroying the gate oxide between gate and source, a high voltage is already sufficient and no high current has to flow, such that an electronic fuse with a transistor might be preferred for some applications compared to an electronic fuse with a thin conductor piece.

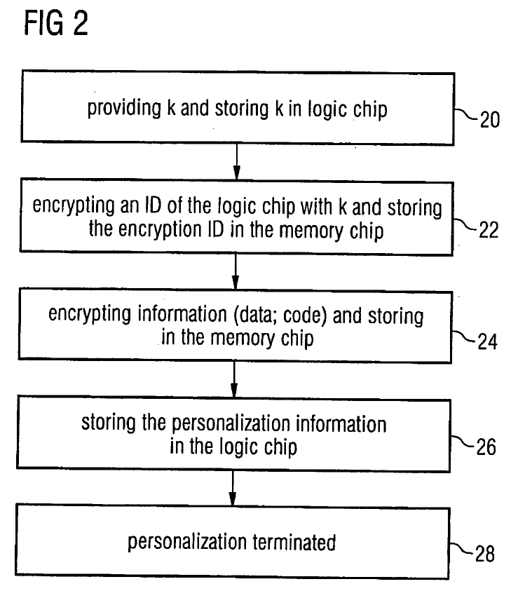

The memory chip 14 includes a non-volatile memory and is preferably designed as a flash memory. It includes a non-volatile memory area for storing encrypted identification information of the logic chip. It should be noted that it is preferred to store encrypted identification information at a predetermined address of the memory chip 14 or generally at a position known to the logic chip, respectively, such that a verification can be performed, as will be described below. In the following, a preferred process for allocating a logic chip, for example the logic chip 12 of FIG. 1, to a memory chip, for example the memory chip 14 of FIG. 1 will be illustrated with regard to FIG. 2. In a first step 20, preferably performed by the logic chip, the same selects a secret key k. This secret key can, for example, be a real random number. However, this is not necessarily required. Here, any deterministically determined number or pseudo-random number could be used. This number, which means the key k, is then stored in the non-volatile memory 120a of the logic chip 12. If this non-volatile memory is designed as a block of fuses, the secret key k is burned into the fuse block, wherein it is preferred to leave at least one fuse free, since the same, as will be discussed below, contains personalization information. In the example shown in FIG. 1, this would be the fuse 13d not touched in step 20.

In a step indicated by 22 in FIG. 2, then, again preferably by the logic chip, an identification m of the logic chip is encrypted by using the key k and an encryption algorithm A to obtain an encrypted identification of the logic chip designated by c. This value c is then stored in the identification memory area 16 of the memory chip 14. In a preferred embodiment of the present invention, it is preferred to store not only the identification of the logic chip in the memory chip in an encrypted way, but to also store all other data or at least part of the data or codes, respectively, stored in the memory chip, in an encrypted way. Therefore, in a step 24 of FIG. 2, an encryption of information, such as data or code, is performed to then store those encrypted data in the memory chip 14. It should be noted that for encrypting the useful data to be stored in the memory chip, the same key k can be used. However, another key can be used, such as the identification of the logic chip or, for example, part of the identification information of the logic chip. Alternatively, any other key or any encryption algorithm can be selected, as long as information about the selected key or the selected algorithm, respectively, are known to the CPU in order to be able to decrypt the data encrypted in the memory during the operation of the processor circuit in order to be able to operate with the same.

In a step 26, the personalization process is then terminated by storing personalization information in the logic chip. Therefore, preferably, the so far not touched last fuse 13d of FIG. 1 is used to burn the same, which means to put it into a certain state. Thereby, it is signalized that the logic chip has been personalized, in other words that a memory chip has been uniquely allocated to the logic chip. Then, after the personalization information has been terminated, the termination of the personalization is determined in a step 28.

Thus, a secret key, such as a real random number k is selected by the logic chip and burned into the fuse block, wherein at least one additional fuse bit is not yet used. It should be noted that this can already be performed in the semiconductor factory, wherein then, however, the random number or the key k, respectively, associated to the logic chip, has to be read out from the fuse block prior to the actual personalization on the circuit board to perform the respective encryption. Storing a key in the logic chip already at the factory also allows not only that a fuse block is used but, for example, also a read-only memory (ROM), since this number can already be stored in the logic chip itself via an ROM mask for the chip. Since the logic chips typically also contain stored identification information, storing the random number in the logic chip can also be performed simultaneously with storing the logic ID, wherein also the same memory chip, for example ROM, fuse, flash, etc., can be used.

The logic chip uses an algorithm A for secret keys to encrypt a certain unique number m for the logic chip L in c: =Aₖ(m). This encrypted number, unique for the logic chip, which means the identification information, is then written to a determined fixed place, namely the region 16 of the memory chip 14 of FIG. 1. Preferably, the logic chip encrypts the whole memory or at least relevant parts of the same by using the key k or another key and then continues the personalization, which means the allocation of the logic chip to the memory chip. Then, the remaining fuse bit 13d is set so that the chip package consisting of logic chip L and memory chip M is “concatenated”.

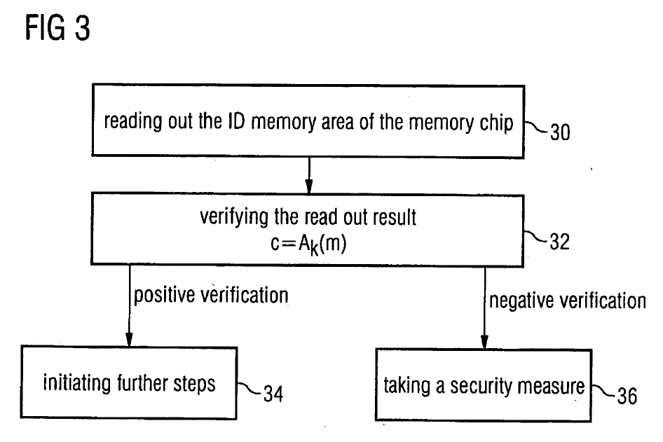

In the following, with reference to FIG. 3, a method of operating the processor circuit of FIG. 1 according to a preferred embodiment of the present invention will be illustrated. In a step 30, first, the ID memory area 16 of the memory chip is read out to obtain a read-out result. Therefore, a certain predefined address is used, whereby it is expected that the encrypted identification date of the logic chip stored during personalization is stored at this address. In a step 32, the read-out result obtained by step 30 is verified by reading out the key k from the logic chip and particularly from the first memory area 120a of the logic chip, so that the chip identification m read out from the logic chip, by determining the encryption algorithm and by calculating c=Aₖ(m). If this encrypted identification c calculated during verification is equal to the identification read out from the memory chip, this represents a positive verification which causes further steps to be enabled (34), for example that booting the CPU contained on the logic chip is continued. If, however, it is determined that the verification performed in step 32 leads to a negative result, a security measure is taken in a step 36, such as a security reset, a trap to the operating system, an output interruption, an error message, an alarm, etc.

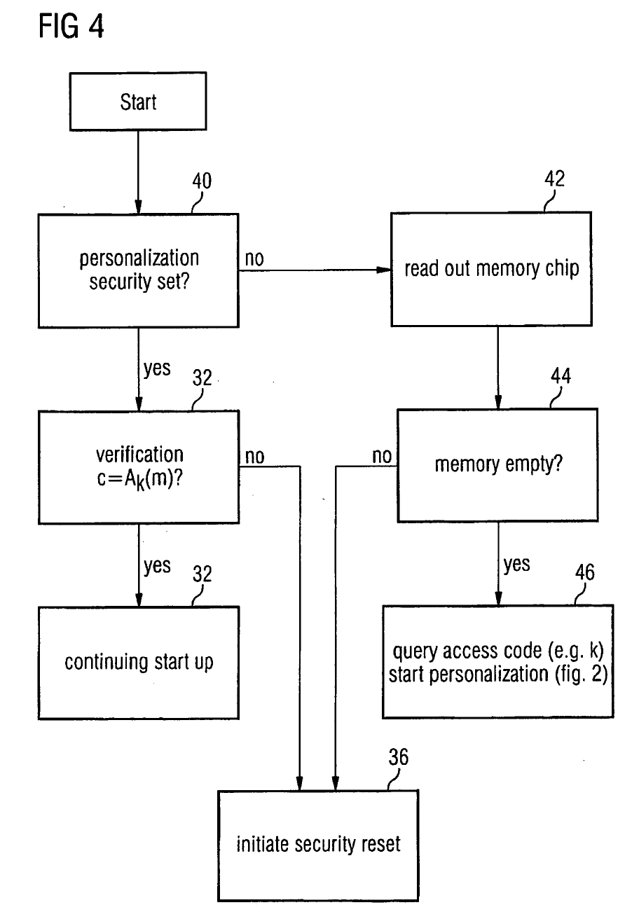

In a preferred embodiment, where the personalization information bit 13d is used, first, as illustrated in FIG. 4, it is checked in a step 40 whether the personalization fuse is set or burned, respectively, or not. If the answer to this question is yes, the verification illustrated with regard to FIG. 3 is performed in step 32 to either continue the starting up (step 32) or to initiate a security measure, such as a security reset (step 36), depending on the verification result. If, however, it is determined that the personalization fuse is not set, which indicates that no personalization of a memory chip to a logic chip has taken place, the relevant memory chip is read out in a step 42. If it is determined in a step 44 that the memory is empty, this indicates that the memory has not yet been personalized and is now to be personalized. This will be performed in a step 46, wherein, for example, an access code is queried, such as the key k stored in the first memory area 120a of the logic chip, which is required to perform the steps illustrated in FIG. 2 for personalizing the memory chip and the logic chip.

If, however, it is determined that the memory is not empty, this indicates that very likely a manipulation has been performed at the personalization bit of the logic chip, since, according to definition, a memory of a memory chip can only be empty when simultaneously the personalization information of an associated logic chip is not set. Thus, the memory check in step 44 of FIG. 4 has the effect that when a non-empty memory is determined, also a security reset is initiated (step 36 of FIG. 4).

The present invention is advantageous in that when an attacker fully deletes the memory chip and starts the booting process as illustrated with regard to FIG. 4, the personalization bit still signalizes that the chip has been fully personalized. The then starting security reset avoids further intrusion of the attacker based on the deleted memory. In that case, the verification illustrated in FIG. 3 in step 32 would fail, since only zeros are in the ID memory area, which means no encrypted identification c. The verification 32 would thus have a negative result, which initiates the security reset in step 36.

If, however, the attacker replaced the original code by another code, this would also be noticed during verification if the attacker had manipulated the memory area 16 of the memory chip 14. If an attacker was able to leave this region non-manipulated, this would not help him much, since, in a preferred embodiment of the present invention, the whole content of the memory chip or at least relevant parts of the same are encrypted.

Here, it should be noted that other variations are possible. It is, for example, possible that another key k′ is used instead of the key k to encrypt the content of the memory M. This key k′ could, for example, be part of the chip ID m or be derived in another way such that it can be determined or reconstructed, respectively, by the logic chip.

Depending on practical conditions, the inventive methods can be implemented in hardware or in software. The implementation can be made on a digital memory medium, particularly a disc or CD with electronically readable control signals, which can cooperate with a programmable computer system such that the corresponding method is performed. Generally, the invention thus also consists in a computer program product with a program code for performing the inventive method stored on a machine-readable carrier, when the computer program product runs on a computer. In other words, the invention represents a computer program with a program code for performing the method when the computer program runs on a computer.

It will therefore be appreciated that the present invention is based on the knowledge that particularly for inexpensive applications, where an integration of a non-volatile memory with a logic element is not required, for example, for cost reasons, a secure allocation of a separate logic chip to a separate memory chip can still be obtained by providing the logic chip with a memory area, which is preferably formed in the form of electronic fuses, in which a cryptographic key is stored. With this cryptographic key, identification information unique for the logic chip is encrypted, wherein a certain cryptographic algorithm can be used, which is, depending on the application, a cryptographic algorithm with high security, such as the DES or RSA algorithm, or can also be a simple coding algorithm for other applications, which uses a certain coding depending on the key. The identification information of the logic chip encrypted with the key is then stored in a memory area of the non-volatile memory of the memory chip, such that allocation between logic chip and memory chip is made.

Further, after the allocation of the two chips has been accomplished, which means after personalization of the logic chip to the memory chip has been accomplished, it is preferred to store personalization information in the memory area of the logic chip, which signalizes that a memory chip has been allocated to this logic chip, i.e. that the logic chip has been personalized to a memory chip. Therefore, it is also preferred to use one or several available electronic fuses to store both the key and the personalization information in an irreversible way or at least in a non-volatile way after personalization has been accomplished in the fuse region of the logic chip.

When starting up the logic chip, or before the logic chip accesses information from the memory chip, respectively, the key stored in the memory area of the logic chip is read out. Then, the identification information of the logic chip is encrypted with this key to obtain encrypted identification information, which will then be compared to the encrypted identification information in the non-volatile memory area of the memory chip. If this verification determines that both data match, this means that the correct memory chip is allocated to the logic chip. If, however, it is determined that the encrypted identification information generated when starting up the logic chip does not match corresponding information, it can be concluded that the memory chip has been manipulated, is erroneous or has been deleted intentionally or unintentionally. In all those cases, the logic chip will refuse its normal operation and will take measures, such as a security reset.

Further, in the case where personalization information is stored in the memory area of the logic chip, which indicates that a memory chip has been allocated to this logic chip, which also means that the logic chip has been personalized, it is preferred to first check the personalization information in order to initiate the verification operation as described above only when the personalization information indicates that a personalization has already taken place.

If, in that case, it is determined that no personalization has taken place, the method will be continued in that it is checked whether the memory of the logic chip is empty. If this is the case, an individual personalization routine can be initiated. If, however, it is determined that the memory is not empty, this indicates that a manipulation has taken place somewhere, which again causes security measures to be taken in order to decide whether the logic chip should now refuse its operation or proceeds in normal operation or possibly continues in a limited operation, etc.

The present invention is advantageous in that a secure and simple allocation of a logic chip to a memory chip is also obtained for non-specialized applications, such as, for example, chip cards.

It is another advantage of the present invention that the processor circuit according to the invention is, one the one hand, very powerful and, on the other hand, inexpensive, since logic circuits and memory circuits do not have to be integrated on the same chip, for security reasons, but that for the separate circuits, separate optimized processes with regard to cost and performance can be used without having to cope with tradeoffs with regard to the secure allocation of these two chips to each other.

It is another advantage of the present invention that the allocation can be easily obtained, since only little effort is required, which can already be performed in the factory where the printed circuit boards with logic chip and memory chip are produced, without requiring customer or service technicians, respectively.

It is another advantage of the present invention that no memory processes, etc., are required at all, particularly when the key and possibly the personalization information are stored in the logic chip by using electronic fuses. Electronic fuses can be produced very inexpensively, wherein herefore, basically, only one single transistor is required for one fuse, which carries first information when it is not “shot”, and which stores another information in an irreversible way when it is “shot” or “burned”.

While this invention has been described in terms of several preferred embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A processor circuit comprising:
a logic chip with a logic circuit and a non-volatile memory;
a memory chip with a non-volatile memory;
wherein the non-volatile memory of the logic chip is a memory area wherein a key is stored, and
wherein the non-volatile memory of the memory chip comprises an identification memory area wherein an identification of the logic chip encrypted by using the key is stored; and
wherein the non-volatile memory of the logic chip comprises a further memory area wherein personalization information is stored, indicating in a set state that the logic chip and the memory chip are allocated to each other, and indicating in a non-set state that the logic chip is not allocated to a memory chip.

2. The processor circuit according to claim 1, further comprising:
a carrier on which the logic chip and the memory chip are disposed.

3. The processor circuit according to claim 1,
wherein the non-volatile memory of the logic chip comprises a block with a plurality of electronic fuses that are programmable in an irreversible way.

4. The processor circuit according to claim 3,
wherein at least one electronic fuse is provided for storing the personalization information in the non-volatile memory of the logic chip.

5. The processor circuit according to claim 1,
wherein the non-volatile memory of the memory chip is a non-volatile memory, which is only deletable as a whole.

6. The processor circuit according to claim 1,
wherein the non-volatile memory of the memory chip is a flash memory.

7. The processor circuit according to claim 1,
wherein at least part of the information stored in the memory chip is stored by using a storage key, wherein the storage key can be generated from information from the logic chip.

8. The processor circuit according to claim 7, wherein the memory key is equal to the key or corresponds at least partly to the identification of the logic chip.

9. The processor circuit according to claim 1, wherein the key stored in the non-volatile memory is a random number.

10. The processor circuit according to claim 1,
wherein the memory chip stores data and code.

11. The processor circuit according to claim 1,
wherein the logic chip comprises a CPU.

12. The processor circuit according to claim 2,
wherein the carrier is a circuit board.

13. A method of allocating a logic chip to a logic circuit and a non-volatile memory to a memory chip with a non-volatile memory, comprising the steps of:
providing a key and storing the key in the non-volatile memory of the logic chip;
encrypting an identification of the logic chip by using the key to obtain an encrypted identification; and
storing the encrypted identification of the logic chip in an identification memory area of the non-volatile memory of the memory chip;
storing personalization information in the non-volatile memory of the logic chip, wherein the personalization information indicates in a set state that the logic chip and the memory chip are allocated to each other, and wherein the personalization information indicates in a non-set state that the logic chip is not allocated to a memory chip.

14. The method according to claim 13, wherein the non-volatile memory wherein the key is stored comprises a block with electronic fuses.

15. The method according to claim 13, wherein the step of storing the personalization information in the non-volatile memory of the logic chip is performed after the step of encrypting and storing the encrypted identification in the memory chip.

16. The method according to claim 13, further comprising the steps of:
encrypting information by using an information key to obtain encrypted information; and
storing the encrypted information in the non-volatile memory of the memory chip.

17. The method according to claim 16, wherein the step of storing the personalization information in the non-volatile memory of the logic chip is performed after storing the encrypted information.

18. The method according to claim 13, wherein the non-volatile memory of the logic chip is read out prior to the step of encrypting the identification in order to determine whether the personalization information is already included,
wherein in the case of a positive answer the memory chip is read out, and
wherein in the case when the memory is empty, the steps of providing a key, encrypting an identification and storing the encrypted identification are performed.

19. A method of operating a processor circuit with a logic chip with a logic circuit and a non-volatile memory and a memory chip with an identification memory area and a further memory area, comprising the steps of:
reading out the identification memory area of the logic chip to obtain a read-out result;
reading out the further memory area of the non-volatile memory of the logic chip to obtain a read-out result;
determining whether the read-out result includes personalization information, wherein the personalization information indicates in a set state that the logic chip and the memory chip are allocated to each other, and wherein the personalization information indicates in a non-set state that the logic chip is not allocated to a memory chip; and
verifying that the read-out result is an identification of the logic chip encrypted by using the key stored in the logic chip, only when the personalization information indicates in a set state that the logic chip and the memory chip are allocated to each other;
with a positive result of the step of verifying, enabling further steps, where the logic chip and the memory chip are involved, otherwise taking a security measure.

20. The method according to claim 19, wherein the step of verifying comprises the steps of:
reading out the key from the non-volatile memory of the logic chip;
obtaining an unencrypted identification of the logic chip;
encrypting the unencrypted identification with the key to obtain an encryption result;
comparing the encryption result with the read-out result.

21. The method according to claim 19, wherein in the case where the read-out result comprises the personalization information in a non-set state, the non-volatile memory of the memory chip is read out to take a security measure in a case when the memory is not empty.

22. A computer program with a program code for performing the method of allocating a logic chip to a logic circuit and a non-volatile memory to a memory chip with a non-volatile memory, comprising the steps of:
providing a key and storing the key in the non-volatile memory of the logic chip;
encrypting an identification of the logic chip by using the key to obtain an encrypted identification;
storing the encrypted identification of the logic chip in an identification memory area of the non-volatile memory of the memory chip; and
storing personalization information in the non-volatile memory of the logic chip, wherein the personalization information indicates in a set state that the logic chip and the memory chip are allocated to each other, and wherein the personalization information indicates in a non-set state that the logic chip is not allocated to a memory chip,
when the computer program runs on a computer.

23. A computer program with a program code for performing the method of operating a processor circuit with a logic chip with a logic circuit and a non-volatile memory and a memory chip with an identification memory area and a further memory area, comprising the steps of:
reading out the identification memory area of the logic chip to obtain a read-out result;
reading out the further memory area of the non-volatile memory of the logic chip to obtain a read-out result;
determining whether the read-out result includes personalization information, wherein the personalization information indicates in a set state that the logic chip and the memory chip are allocated to each other, and wherein the personalization information indicates in a non-set state that the logic chip is not allocated to a memory chip; and
verifying that the read-out result is an identification of the logic chip encrypted by using the key stored in the logic chip, only when the personalization information indicates in a set state that the logic chip and the memory chip are allocated to each other;
with a positive result of the step of verifying, enabling further steps, where the logic chip and the memory chip are involved, otherwise taking a security measure,
when the computer program runs on a computer.

24. A processor circuit comprising:
a logic chip with a logic circuit and a non-volatile memory;
a memory chip with a non-volatile memory;
wherein the non-volatile memory of the logic chip is a memory area wherein a key is stored, and
wherein the non-volatile memory of the memory chip comprises an identification memory area wherein an identification of the logic chip encrypted by using the key is stored; and
wherein the non-volatile memory of the logic chip comprises a further memory area wherein personalization information is stored, wherein the logic chip is configured to permit the key and the personalization information to be stored simultaneously.
